(19) United States
(12) Patent Application Publication
(10) Pub. No.: US 2015/0239729 A1
(43) Pub. Date: Aug. 27, 2015

(54) Saddle Underlay

(71) Applicant: METZELER SCHAUM GMBH, Memmingen (DE)

(72) Inventor: Manfred Gehring, Memmingen (DE)

(73) Assignee: Metzeler Schaum GmbH, Memmingen (DE)

(21) Appl. No.: 14/428,810

(22) PCT Filed: Sep. 13, 2013
(86) PCT No.: PCT/EP2013/069005

§ 371 Date: Mar. 17, 2015

(30) Foreign Application Priority Data
Sep. 18, 2012 (DE) 20 2012 103 575.8

(51) Int. Cl. B68C 1/12; B68C 1/02

(52) U.S. Cl. CPC B68C 1/12; B68C 1/02

(57) ABSTRACT

The present invention relates to a saddle underlay (10) for placement on a riding animal, comprising at least one layer made of a sheet structure (11), the sheet structure (11) being formed from a plurality of spring members (14). In order to ensure improved ventilation, it is proposed that at least one spring member (14) has a passage (16) for air circulation and for discharging moisture. Furthermore, the invention relates to a saddle system (40) comprising a saddle underlay (10) according to the invention.

### TECHNICAL FIELD

The present invention relates to a saddle underlay for placement on a riding animal, comprising at least one layer made of a sheet structure, the sheet structure being formed from a plurality of spring members. Furthermore, the invention relates to a saddle system comprising a saddle underlay according to the invention.

### BACKGROUND OF THE INVENTION

Saddle underlays, which are also referred to as saddle pads, are disposed between a saddle and the back of a riding animal, in particular of a horse, or between a saddle and a saddle blanket placed on the back of the riding animal. Here, the saddle underlay compensates fitting inaccuracies between the riding animal and the saddle. Furthermore, the saddle underlay serves for damping, so that a protection of the back of the riding animal is achieved.

In this case, the use of saddle underlay pads made from lambskin, polyurethane foam or gel-filled pads is known.

For example, the production of a saddle blanket, which is provided with holes in order to ensure sufficient ventilation, from an undercured polyurethane foam is known from DE 296 08 974 U1.

A saddle underlay is presented in DE 202 007 003 161 U1, which is produced from a plurality of bodies made from damping plastic that are placed in a row and connected to each other, an intermediate space for ventilation purposes being present between the connecting portions of the bodies.

A drawback of the known saddle underlays is that they provide insufficient ventilation. This may result in a heat accumulation.

Therefore, the invention is based on the object of providing a saddle underlay of the type mentioned in the introduction, which ensures improved ventilation.

### SUMMARY OF THE INVENTION

A saddle underlay with the features of claim 1 and a saddle system are proposed in order to achieve this object.

Advantageous embodiments of the saddle underlay according to the invention and the saddle system according to the invention are the subject matter of the dependent claims.

In the saddle underlay according to one or more embodiments of the invention, at least one spring member has a passage for air circulation and for discharging moisture. The passage ensures an improved air circulation and the discharge of moisture, so that a heat accumulation between the saddle and the back of the riding animal is avoided. In addition, the spring members enable an advantageous damping action and, associated therewith, an improved protection of the riding animal.

In an advantageous embodiment, each of the spring members has a passage for air circulation and for discharging moisture.

Advantageously, a free space for air circulation and for discharging moisture is formed between adjacent spring members. Due to the large-surface cut-outs, an improved breathability is thus provided.

Advantageously, a surface of the sheet structure that can be made to face the back of the riding animal is provided with a profile. The profiled surface prevents the saddle underlay from slipping on the back of the riding animal and/or on a saddle blanket during riding. In addition, a maximum damping action and application of pressure in the direction of the back of the riding animal is provided due to the profiled surface. Advantageously, the profile is formed from raised and de-pressed portions, with the end portions of the raised portions being rounded. Furthermore, the end portions may also be configured in a triangular and/or wavy shape.

In an advantageous embodiment, the profile depth is between 3 and 12 mm, preferably between 5 and 10 mm.

Advantageously, the spring members have an octagonal contour in cross section. However, it is also conceivable to select many different forms, such as, for example, a shape which, in cross section, is circular or another angular shape. Moreover, it is also conceivable to use a cross-sectional shape that changes across the height of the spring member, such as a waisted shape. By providing the external jacket surface of the spring member with such a shape, its deformation behavior can be influenced.

Preferably, the passages are disposed approximately centrally. Advantageously, the passages have, in cross section, a straight or curved shape. As a consequence of the central arrangement of the passage, it is possible that the spring member deforms largely symmetrically if put under stress, and that thus the first portions of the spring member are stressed largely uniformly. Furthermore, it is also possible to position the recess in such a way that a certain deformation behavior is obtained. In addition, the deformation behavior of the spring member can be controlled or influenced by the shape provided to the recess. Furthermore, the shape of the recess can be variable along the direction of its extent within the spring member, such as conical, for example.

Advantageously, the height of the at least one layer is between 10 mm and 15 mm. An optimum damping action is thus achieved, and at the same time, enough material is provided for incorporating a profile.

In an advantageous embodiment, the sheet structure is manufactured from polyurethane flexible foam. Advantageously, this is an open-cell flexible foam, so that the transport of heat and moisture is additionally improved. The polyurethane flexible foam can be brought into any shape in a simple manner by means of foam-molding and thus, spring members of many different shapes can be produced, depending on the case of application and desired material parameters, such as elasticity and permeability values. It is thus possible to produce the saddle underlay according to the invention in different degrees of hardness. For example, the saddle underlay may be offered with the hardness degrees soft, medium and hard. Furthermore, polyurethane flexible foam is advantageous with regard to long-term and continuous durability.

In order to produce one or a plurality of spring members, a reaction mixture is filled into a foaming mold and brought into the final shape by foaming. In order to be able to form the passage, the foaming mold is advantageously configured in such a manner that the spring member is provided with the passage already by the foaming process. Subsequent drilling or cutting can thus be dispensed with.

In an advantageous embodiment, the sheet structure is foamed integrally. The sheet structure has a plurality of interconnected spring members. In this way, a sheet structure with any number of spring members can be assembled. Advantageously, the substance-to-substance connection of the spring members is at least partially elastic in order to prevent too rigid a connection of the spring members. Advantageously, the spring members are disposed side-by-side in such a way that a free space is provided in a region between the outer surfaces of adjacent spring members. This is achieved, in particular, by selecting a suitable cross-sectional shape of the spring member. An octagonal outline is particularly suitable for the spring member. The free space formed between the spring members can also be used for the transport of heat and moisture.

Furthermore, one or more embodiments of the invention relate to a saddle system, comprising a saddle, a saddle blanket and a saddle underlay as described above disposed between the saddle and the saddle blanket. The saddle system is characterized, in particular, by a saddle underlay, which is disposed between the saddle and the saddle blanket also referred to as a saddle cloth, and which provides for an advantageous air circulation and the discharging of moisture, so that a heat accumulation between the saddle and the back of a riding animal is avoided. Furthermore, an improved damping action, and thus a protection of the back of the riding animal, is achieved.

Advantageously, the saddle blanket can be connected to the saddle by means of a fastening strap attached thereto, with the fastening strap being guided through at least one passage and/or one free space of the saddle underlay.

### BRIEF DESCRIPTION OF THE DRAWING FIGURES

The invention will be explained in more detail below with reference to the schematic drawings. In the Figures:

FIG. 1 shows a perspective view of the saddle underlay according to an embodiment of the invention; and

FIG. 2 shows a cross section through the saddle system according to an embodiment of the invention.

### DETAILED DESCRIPTION OF THE INVENTION

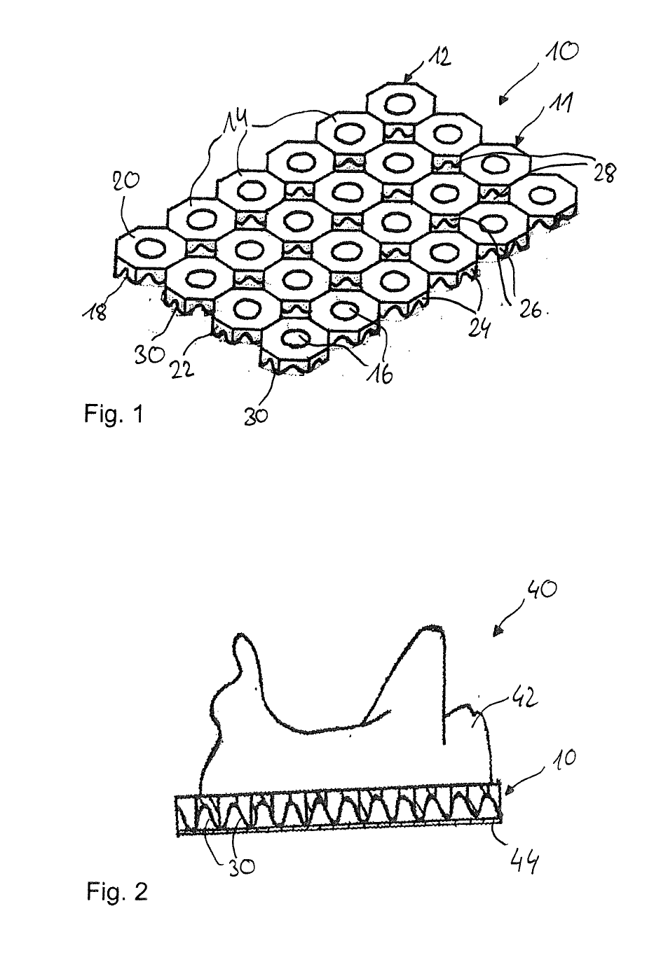

FIG. 1 illustrates a saddle underlay 10 according to an embodiment of the invention, which is produced from an elastic, open-cell polyurethane flexible foam by foam-molding.

The saddle underlay 10 has a sheet structure 11 in the form of a spring member unit 12 formed from a plurality of spring members 14.

Each of the spring members 14 has an octagonal cross-sectional shape, with a passage 16 extending centrally from an underside 18 to a top side 20 of the spring member 14. Furthermore, each of the spring members 14 has a jacket surface 22 divided into connecting surfaces 24 and free surfaces 26.

Via the connecting surfaces 24, the individual spring members 14 are connected to one another in such a way that the free surfaces 26 form a free space 28 formed continuously from the underside 18 of the spring member to the top side 20 of the spring member 14. Both the passage 16 and the free space 28 serve as air ducts for transporting heat and moisture.

The individual spring members 14 are connected to one another by substance-to-substance connection on their connecting surfaces 24. In this case, the individual spring members 14 can be connected to one another either by means of an adhesive connection or already during the foaming of the spring members.

A profile 30 preventing the saddle underlay 10 from slipping during riding is provided on the underside 18 of the spring members 14. The profile 30 is formed from raised and depressed portions, with the end portions of the raised portions being configured in the form or rounded knobs. In addition, it is also conceivable to configure the end portions in the form of triangles and/or waves.

The saddle underlay 10 is produced by foam-molding, with corresponding mold cores for forming the passages 16 and the free spaces 28 being incorporated in the foaming mold. Furthermore, it is also possible to produce the spring elements 14 individually by foam-molding and then connect them to one another by means of an adhesive connection on their connecting surfaces 24.

Due to the manufacture of the saddle underlay 10 according to an embodiment of the invention from polyurethane flexible foam, it is possible to produce the saddle underlay 10 in different degrees of hardness, such as soft, medium or hard, for example. In the present exemplary embodiment, the saddle underlay 10 is configured in a rectangular shape, with it also being conceivable to configure the saddle underlay 10 to have an approximate saddle-shape by the foaming mold having a corresponding contour, or to cut the saddle underlay 10 accordingly after foaming.

FIG. 2 shows a saddle system 40 according to an embodiment of the invention, which comprises a saddle 42, a saddle blanket 44 and the saddle underlay 10. The saddle underlay 10 is disposed between the saddle 42 and the saddle blanket 44, with the profile 30 pointing in the direction of the saddle blanket 44. For an adequate connection of the individual elements of the saddle system 40, a fastening strap, which is not shown and which is connected to the saddle 42, is attached to the saddle blanket 44, wherein the fastening strap is guided through a passage 16 and/or one free space 28.

The saddle underlay 10 according to the depicted embodiment is characterized by the passages 16 incorporated into the spring members 14, and by free spaces 28, which are disposed between the spring members and which serve for an improved air circulation and discharge of moisture. A heat accumulation between the saddle 42 and the back of the riding animal can thus be avoided. In addition, the spring members 14 enable an advantageous damping action and, associated therewith, an improved protection of the back of the riding animal. Furthermore, the profile prevents the saddle underlay 10 from slipping underneath the saddle 42 during riding.

### REFERENCE SIGN LIST

10 Saddle Underlay
11 Sheet structure
12 Spring member unit
14 Spring member
16 Passage
18 Underside
20 Top side
22 Jacket surface
24 Connecting surface
26 Free surface
28 Free space
30 Profile
40 Saddle system
42 Saddle
44 Saddle blanket

1. A saddle underlay for placement on a riding animal, comprising
at least one layer made of a sheet structure, the sheet structure being formed from a plurality of spring members, and
at least one of the spring members having a passage for air circulation and for discharging moisture.

2. The saddle underlay of claim 1, in which each of the spring members has a passage for air circulation and for discharging moisture.

3. The saddle underlay of claim 1, in which a free space for air circulation and for discharging moisture is formed between adjacent ones of the spring members.

4. The saddle underlay of claim 1, in which a surface of the sheet structure that can be made to face the back of the riding animal is provided with a profile.

5. The saddle of claim 4, in which the profile has a depth between 3 mm and 12 mm.

6. The saddle underlay of claim 1, in which the spring members have, in cross section, an octagonal contour.

7. The saddle underlay of claim 1, in which the passages are disposed approximately centrally.

8. The saddle underlay of claim 1, in which the passages have, in cross section, a straight or curved shape.

9. The saddle underlay of claim 1, in which the at least one layer made of a sheet structure has a height between 10 mm and 15 mm.

10. The saddle underlay of claim 1, in which the sheet structure is manufactured from a flexible foam.

11. The saddle underlay of claim 1, in which the sheet structure is foamed integrally.

12. A saddle system, comprising
a saddle,
a saddle blanket and
the saddle underlay of claim 1 being disposed between the saddle and the saddle blanket.

13. The saddle system of claim 12, in which the saddle blanket is arranged to be connected to the saddle by a fastening strap attached thereto, with the fastening strap being guided through at least one of (a) the passage in one of the spring members and (b) a free space between adjacent ones of the spring members of the saddle underlay.

14. The saddle underlay of claim 4, in which the profile has a depth-between 5 mm and 10 mm.

15. The saddle underlay of claim 1, in which the sheet structure is manufactured from a polyurethane flexible foam.

16. The saddle underlay of claim 2, in which a free space for air circulation and for discharging moisture is formed between adjacent ones of the spring members.

17. The saddle underlay of claim 16, in which a surface of the sheet structure that can be made to face the back of the riding animal is provided with a profile.

18. The saddle underlay of claim 1, in which the spring members have, in cross section, an octagonal contour and the passages are disposed approximately centrally.

19. The saddle underlay of claim 18, in which the passages have, in cross section, a straight or curved shape.

20. The saddle underlay of claim 1, in which the at least one layer made of a sheet structure has a height between 10 mm and 15 mm and the sheet structure is manufactured from a flexible foam.
